(19) United States
(12) Patent Application Publication
(10) Pub. No.: US 2015/0134675 A1
(43) Pub. Date: May 14, 2015

(54) CONTEXT ASSOCIATION

(71) Applicants: Stephen M. Ellis, Tahoe City, CA (US); Bipin Sahni, San Francisco, CA (US); David Hatch, Daly City, CA (US); Shahid Razzaq, San Francisco, CA (US)

(72) Inventors: Stephen M. Ellis, Tahoe City, CA (US); Bipin Sahni, San Francisco, CA (US); David Hatch, Daly City, CA (US); Shahid Razzaq, San Francisco, CA (US)

(73) Assignee: WELLS FARGO BANK, N.A., Charlotte, NC (US)

(21) Appl. No.: 14/090,862

(22) Filed: Nov. 26, 2013

Related U.S. Application Data
(63) Continuation-in-part of application No. 14/080,266, filed on Nov. 14, 2013.

(51) Int. Cl. G06F 17/30

(52) U.S. Cl. CPC G06F 17/30699
USPC 707/754

(57) ABSTRACT

One or more embodiments of techniques or systems for search context association are provided herein. Search context association can include search filtering and/or search expansion. For example, when a query is submitted, data or data sets can be filtered to narrow a search or expanded such that additional data sets or queries are included. Data or data sets can be aggregated, filtered, or expanded based on a context of the query. A context can include user characteristics, environmental factors, social media factors, route based characteristics, or destination based characteristics. As an example, when a new product (e.g., a new mobile phone) is released, limited quantities may be available. Users may be directed to different retailers or stores based on inventory levels, length of lines (which may be determined using social media among other things), distance, and the like.

### CROSS-REFERENCE TO RELATED APPLICATIONS

This application is a continuation-in-part (CIP) of and claims priority to U.S. Non-Provisional patent application Ser. No. 14/080,266 (Attorney Docket No. 106750.43US1) entitled “INTELLIGENT DATA PRESENTATION”, filed on Nov. 14, 2013; the entirety of the above-noted application is incorporated by reference herein.

### BACKGROUND

Generally, a database engine or data engine is a component that a database management system uses to access a database. For example, a data engine can create, read, update, modify, or delete data from a database. When a user submits a query, a data engine may search a search index and provide a listing of one or more matches based on one or more criteria. Often a search index is built from information stored with data or may include metadata based on how information or data is indexed. Additionally, a data engine may search for words or phrases exactly as entered or using a natural language search. Once the data engine returns one or more results or one or more matches, a visualization may be presented for one or more of the results.

A visualization is a way or a type of rendering which facilitates data presentation to a user. For example, a visualization may be a bar graph, a chart, a scatter plot, etc. When data from a data set is visualized or presented, such as by a visualization system, visualizations are often tightly coupled with the data set that is being presented. This means that a data set may be presented using merely one type of visualization. For example, when a data set is two-dimensional or 2-D, the data set may include one or more columns of data entries and one or more rows of data entries. The columns of the data set may represent features or fields, while the rows of the data set may correspond to records of those features or fields. However, as a data set is updated, such as when the number of rows or the number of columns changes, the generated visualization may no longer remain effective. That is, program code or source code for generating a visualization may follow assumptions related to a structure of the data set or a format of the data set. As a result, a visualization generated from this source code may be tightly coupled with the data set. In this way, data sets are often presented in a limited manner, by making certain assumptions about the structure of data, for example.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

One or more embodiments of techniques or systems for search context association, search filtering, and search expansion are provided herein. Often, when a query is received, merely the terms within the query are used to narrow or conduct a search. For example, when a user is searching for automated teller machines (ATMs), the user may submit a query which includes the term “ATM” and a zip code or other location indicia. In one or more embodiments, a context may be determined for the query. That is, extraneous data which is not included in the query can be included or appended when considering search terms or search results, for example. In other words, data horizons can be expanded for a search query or filters can be added based on the context for the query. However, it will be appreciated that the context of the query can be used to expand or restrict a scope of a search or a query. With regard to a query for an ATM which includes a zip code, environmental factors or other contextual data, such as weather information, may be used to filter, aggregate, rank, or score different ATMs. In this example, users may be provided with the location, distance, and weather information associated with one or more different ATMs. If it is snowing out, the user may be directed to an ATM where less snow has accumulated on the ground. In one or more embodiments, a data engine may suggest an ATM which is located indoors or covered from the elements or snow, thereby associating a search context with a query.

The following description and annexed drawings set forth certain illustrative aspects and implementations. These are indicative of but a few of the various ways in which one or more aspects are employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is an illustration of an example component diagram of a system for search context association, according to one or more embodiments.

FIG. 2 is an illustration of an example flow diagram of a method for search context association, according to one or more embodiments.

FIG. 3 is an illustration of an example flow diagram of a method for search context association, according to one or more embodiments.

FIG. 4 is an illustration of an example rendering for search context association, according to one or more embodiments.

FIG. 5 is an illustration of an example rendering for search context association, according to one or more embodiments.

FIG. 6 is an illustration of an example rendering for search context association, according to one or more embodiments.

FIG. 7 is an illustration of an example computer-readable medium or computer-readable device including processor-executable instructions configured to embody one or more of the provisions set forth herein, according to one or more embodiments.

FIG. 8 is an illustration of an example computing environment where one or more of the provisions set forth herein are implemented, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

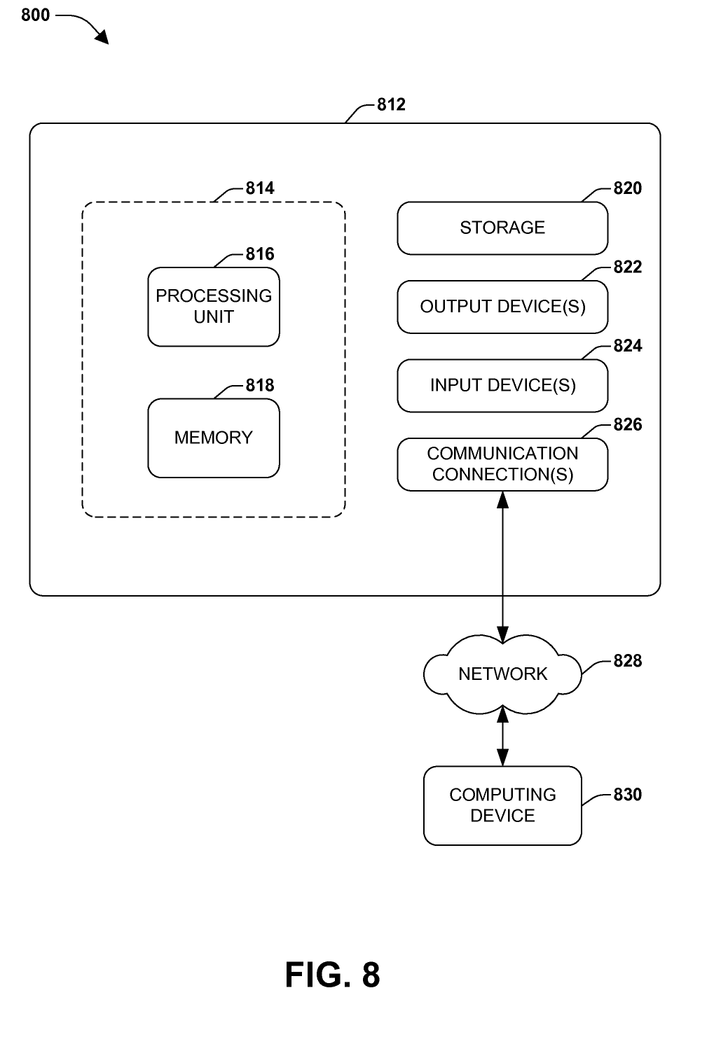

For one or more of the figures herein, one or more boundaries, such as boundary 814 of FIG. 8, for example, are drawn with different heights, widths, perimeters, aspect ratios, shapes, etc. relative to one another merely for illustrative purposes, and are not necessarily drawn to scale. For example, because dashed or dotted lines may be used to represent different boundaries, if the dashed and dotted lines were drawn on top of one another they would not be distinguishable in the figures, and thus may be drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but can encompass a portion of one or more other components as well.

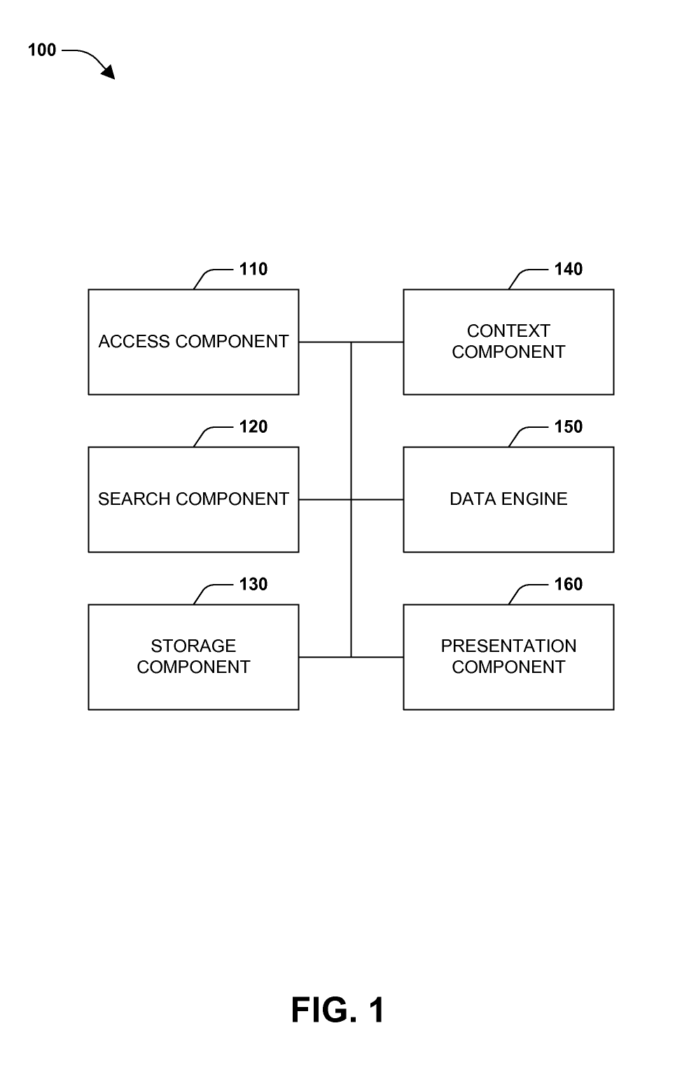

FIG. 1 is an illustration of an example component diagram of a system 100 for search context association, according to one or more embodiments. The system 100 of FIG. 1 can include an access component 110, a search component 120, a storage component 130, a context component 140, a data engine 150, and a presentation component 160. The system 100 can facilitate search context association by filtering searches and/or expanding searches (e.g., broadening data horizons).

The access component 110 can enable, grant, deny, or disable access to a data set, such as account information or location information associated with a user. For example, the access component 110 may request permission from a user to access global positioning (GPS) data from a mobile device of the user. In one or more embodiments, the access component 110 may utilize a login, password, security questions, or the like to control access to a data set, account information, GPS locations, etc.

The search component 120 can receive a query for information or a search query. In one or more embodiments, one or more portions of the query or the search query can be input by a user or auto-generated by another component. This means that one or more portions of the received query may be associated with or generated by a user in one or more embodiments. Other portions or search terms of a query may be auto-generated by the context component 140. Additionally, a query may include one or more keywords, such as “mobile phone release and retail locations”, “mobile phone availability”, or be in natural language format, such as “Find me an ATM near 44313”.

The context component 140 can determine a context for the query. In one or more embodiments, a context of a query can be a usage context. For example, when a vehicle is in drive the usage context may be different than when the vehicle is in park. When a user submits a query such as “Find me an ATM” to the search component 120, the context or usage context may be taken into account to filter, narrow, rank, or determine results for the query. Here, in this example, if the vehicle is in drive, the context component 140 may detect that the vehicle is in motion, and infer that the user desires a drive through ATM, rather than ATMs located indoors, such as an ATM located within a grocery store, for example.

Here, in this example, the context component 140 may determine that the usage context or context for the query (e.g., finding the ATM) is a driving environment, and thereby direct a data engine 150 to filter indoor ATMs from the search or provide ATMs where a drive through option is available. That is, as an example, a user may be directed to a second ATM which is farther in distance or driving time than a first ATM which is closer in distance or driving time because the second ATM has a drive through and the first ATM is located indoors.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. For example, the context component 140 can infer a high level event, such as a user travelling to a destination or an ATM based on a query including “ATM” and a zip code. Further, the inference that the user will be traveling may cause the context component 140 to determine a context for the query, which may include environmental factors, such as weather patterns along a route to an ATM, for example.

In another example, if the vehicle is in park or if the vehicle has not yet been started, the context component 140 may infer that the user or driver is willing to leave his or her vehicle. In this example, the context component 140 may direct the data engine 150 to provide locations for most or all of the ATMs. In yet another example, the context component 140 may determine a context for a query based on other extraneous data, one or more user characteristics, financial incentives, time incentives, one or more environmental factors, one or more social media factors, one or more route based characteristics, one or more destination based characteristics, etc.

For example, if a user submits a query for an ATM nearby, the context component 140 can determine a context for the query by analyzing an outside temperature. If temperatures are extreme (e.g., above or below a threshold temperature), the context component 140 may direct a user to an ATM accordingly. For example, if the outside temperature is below zero, the context component 140 may infer that a user would prefer to be indoors while conducting a transaction. That is, the context component 140 may determine that the outside temperature is a factor which should be considered when searching for an ATM. Accordingly, the data engine 150 may filter or score ATMs higher based on an ATM having cover from the elements or ATMs having an indoor location. Here, the data engine 150 can aggregate or filter one or more data sets (e.g., having ATM locations) such that ATMs with indoor locations are shown or presented. As used herein, the term ‘aggregate’ can include compilation, gathering, filtering, narrowing, refining, etc. That is, one or more of the data sets can be indicative of one or more potential destinations (e.g., potential ATMs or other locations where a cash withdrawal transaction may be conducted) as a response to the query. As a result, the context component 140 can effectively append search criteria onto a query submitted by a user. Additionally, the context component 140 can also expand a query, according to one or more embodiments. In this way, the system 100 can be used to manage big data or large, complex collections of data sets.

The context component 140 can infer a context of a query based on a variety of factors, including one or more search terms of a query or a search query, extraneous data (e.g., a news feed, an RSS feed), contextual data, metadata (e.g., popularity of a query, a release date of a product, hype associated with a product, a backlog for backorders of a product). Context can include one or more user characteristics, such as a location of a user, a location associated with a query, a location of one or more destinations, potential destinations and/or corresponding destination locations, or potential matches, a date of a query, a time of a query, one or more tasks associated with a user or on a task list or a to-do list for the user, one or more locations associated with one or more of the tasks, behavioral patterns, search history, action history, past interactions, current interactions, user profile, and the like.

Additionally, context of a query can include one or more environmental factors, such as weather conditions or a weather pattern (e.g., at a location of a user, one or more destination locations, or along one or more routes from the location of the user to one or more of the potential destinations or destination locations), rainfall, snowfall, outside temperatures, natural disasters, topography (e.g., not sending an individual to a low ground ATM during flood season or when it is raining heavily). In one or more embodiments, context can include one or more social media factors, such as social media, feeds, posts, streams, crowd sourcing, online profiles, etc. Further, context can include one or more route based characteristics, such as traffic along a route to a location or destination, traffic patterns, estimated travel times to and/or from a destination, accidents, bus routes, public transit, operating hours, distance associated with one or more routes between the location of the user and one or more of the potential destinations, a coverage map associated with one or more locations and/or one or more destinations, etc. Context may include one or more destination based characteristics, protection from one or more of environmental factors (e.g., cover from the elements, indoor location, outdoor location), crime rate associated with a destination, location, potential match, parking availability and/or parking costs associated with a destination, inventory level, line length, number of people, estimated wait time, crowd density (e.g., number of people per area) or one or more inferred goals of a query (e.g., cost savings, financial incentives, fees, offers, coupons, etc.).

In one example, the context component 140 may determine a context for a query based on route based characteristics, such as parking availability or parking cost. That is, when a user submits a query, such as “Bank 44313”, the context component 140 may infer that the user will travel to a suggested destination (e.g., a suggested bank). Here, the context component 140 may direct the data engine 150 to filter, aggregate, score, or rank one or more destination locations based on these route based characteristics. For example, if a first bank is located along a one way street and a second bank is located on a two-way street, the context component 140 may include ease of access as a query term. For example, an ease of access score may be indicative of how easy, difficult, time consuming, stressful, etc. getting to and/or from a location or destination may be. In one or more embodiments, an ease of access score is higher when a location is easily accessible and lower when a location is not as accessible. That is, one way streets may lower an ease of access score. Similarly, limited parking, a charge for parking, parallel parking, time limits at meters, etc. may influence or affect an ease of access score. In this way, the context component 140 may direct the data engine 150 to rank, score, or aggregate one or more data sets or locations, thereby providing a user with a context for a query.

As another example, if a user initiates a query for a nearby ATM and provides a query which includes “ATM” and a zip code, the context component 140 may cross reference potential destination locations and/or associated routes thereto with coverage maps for cellular phone signals or data coverage from one or more mobile carriers. In one or more embodiments, the search component 120 may prompt the user to provide his or her mobile carrier to facilitate the cross referencing. The context component 140 may have the data engine 150 prioritize, rank, or score potential destinations with better coverage (e.g., more signal or more signal bars) higher than potential destinations with less coverage. In this way, a user may be directed to a destination in a manner such that cellular network or data coverage is accounted for. This means that if a first location (e.g., first ATM) is associated with weaker coverage and a second location (e.g., second ATM) is associated with stronger coverage, the data engine 150 may direct a user to the second location or second ATM based on the stronger coverage (e.g., the context component 140 may make an inference that the user will utilize GPS to navigate to the ATM, and thereby select an ATM which a user has a greater chance of navigating to without dropping the GPS signal and/or having to re-acquire a satellite lock).

In one or more embodiments, the data engine 150 may receive, search for, or analyze one or more data sets based on the query and the context of the query or a goal of a query determined by the context component 140. This enables the data engine 150 to filter or expand a query in an intelligent manner. For example, the data engine 150 may determine a subset of one or more data sets based on the context of the query. That is, when a query is submitted, data or data sets can be filtered to narrow a search (or expanded such that additional data sets or queries are included). Explained yet in another way, data or data sets can be aggregated, filtered, or expanded based on a context of the query. As mentioned, context can include user characteristics, environmental factors, social media factors, route based characteristics, or destination based characteristics.

In other embodiments, the data engine 150 may expand a search or a query. For example, the data engine 150 may initiate a search without a search input or a query from the user. That is, the data engine 150 may auto-generate a search or query without any impetus from the user, such as when resources are idle or it is detected by the context component 140 that the user is initiating or attempting one or more actions which may be inferred as a query to achieve a goal or a precursor to a query, for example. Here, the context component 140 may infer a context for a search based on one or more characteristics of the user. For example, the context component 140 may detect that the second monitor attached to the user's device is idle and initiate a stock tracker query (e.g., generate a query for the search based on the inferred context) based on an occupation of the user (e.g., stockbroker) or a search history for the user (e.g., typically searches for stocks on a particular day or time) or the current market trend (e.g. most active stocks, or ones being talked about most, say on twitter). The data engine 150 may track the query (e.g., aggregate one or more data sets in response to the query based on the inferred context) and provide one or more results for the user based on an inferred context. The data engine 150 can filter one or more of the data sets based on the inferred context. The presentation component 160 can render one or more of the data sets based on the inferred context.

In this way, one or more actions may be suggested to a user which was not user initiated. This means that the system 100 can provide suggestions or suggested results, such as merchant services, value added services, financial services, or other services that enable business to accept transactions or payments via one or more channels (e.g., credit card, debit card, check conversion, automated clearing house (ACH), gift card, loyalty program, payment gateway, merchant cash advance, online transaction processing, point of sale system, electronic benefits transfer, electronic funds transfer, etc.) based on current user activity, past user activity, or available resources, for example.

The presentation component 160 can render one or more results for the query received by the search component 120. That is, the presentation component 160 can render a response to a query based on the query and an associated context, which may be determined by the context component 140. The presentation component 160 can generate or render a pool of one or more results, presentations, renderings, interfaces, or visualizations for a data set from one or more available presentations, renderings, interfaces, or visualizations. In one or more embodiments, the presentation component 160 may generate multiple renderings or presentations and score or select a rendering or presentation from the pool of renderings or presentations. In other embodiments, a presentation to be rendered can be selected and the presentation component 160 renders or generates that presentation or rendering. In other words, a pool of presentations or renderings may be generated upfront in some scenarios and generated on a requested basis in other scenarios. In this way, visualizations or renderings can be tailored to a user based on a context of a query or contextual data.

As used herein, a rendering, a visualization, a presentation, an interface, etc. can refer to or include audio and/or video. In other words, renderings, visualizations, presentations, or interfaces are not limited to a visual presentation, such as a graph or a chart, for example. Additionally, rendering, visualization, presentation, or interface may be used interchangeably herein. However, it will be appreciated that in one or more embodiments, an interface may include one or more visualizations or one or more presentations. Similarly, a rendering may include one or more visualizations or one or more presentations.

A visualization, rendering, chart, graph, presentation, etc. may utilize one or more visual axes or axes. For example, a visualization in the Cartesian coordinate system may utilize an x-axis and a y-axis, while other visualizations, such as 3-D visualizations, may utilize the x-axis, the y-axis, and the z-axis. In one or more embodiments, a presentation, rendering, or visualization generated by the presentation component 160 can be supplemented with additional or higher dimensions of data. This means that the presentation component 160 may supplement, modify, add, aggregate, collect, filter, or tag a data set with additional information, such as color or size, for example. That is, a data set may include two columns and a plurality of rows or records. In one or more embodiments, a visualization of a scatter plot may be created for the data set by the presentation component 160, where the scatter plot may represent a collection of points for the data set.

Here, the presentation component 160 may, as an example, highlight points of the data set which may be suggestions to a user, such as suggested ATM locations to visit. As another possibility, the presentation component 160 may present these points by rendering them with a larger size or a different color, thereby facilitating a higher likelihood that a user will pay more attention to the larger size data points, for example. The context component 140 can detect a context of a query and determine one or more renderings which may be more suitable or have a higher likelihood of being noticed by the user based on the context of the query. For example, when a user is driving a vehicle, the context component 140 may infer that the user is keeping their eyes on the road and render audio rather than video or visualizations which are concentration intensive.

Further, the data engine 150 may assign or score one or more concentration scores or attention scores to one or more portions of one or more renderings. This means that the data engine 150 can determine or estimate how much attention a user may be required to dedicate to a rendering or a portion of a rendering to comprehend or consume that rendering with regard to a given context, such as driving, for example.

In one or more embodiments, the system 100 can provide customers with data or suggestions associated with one or more tertiary customers or one or more retailers. For example, according to one aspect a search component 120 can receive a query (e.g., such as from a retailer) associated with one or more customers or consumers (for the retailer). That is, the query may be request for information or data associated with customers in the area or on the retail premises. The search component 120 may detect a presence of one or more customers or consumers by receiving a notification that a customer is in the area from a mobile device of the consumer, etc. In one or more embodiments, the context component 140 can determine the context for the query based on a physical location of one or more of the consumers. As an example, a retailer may offer one or more discounts or offers to consumers who install a mobile application on their mobile devices. These applications may then alert the search component 120 when the corresponding mobile device and/or user is in the area, on the retailer's premises, or proximate to a location of the retailer.

The context component 140 can determine a context for the query or a context for the customer or consumer, wherein the context of the query is associated with one or more consumer characteristics of one or more of the consumers. A consumer characteristic may include one or more offers, coupons, discounts, etc. received by one or more of the consumers or a location of a consumer. In this way, the context component 140 can determine when an offer, coupon, or gift certificate is presented to a customer or consumer. This means that the retailer may be alerted to one or more spending options which a consumer may have.

The data engine 150 can aggregate one or more data sets, such as coupons, offers, sales, discounts, gift cards, etc. to one or more consumers based on one or more of the consumer characteristics. In other embodiments, the data engine 150 can aggregate one or more of the data sets based on one or more retailer characteristics, such as one or more offers from one or more retailers. The data engine 150 may generate one or more reports or summaries associated with one or more of the aggregated data sets (e.g., number of customers, customer flow, dollar amounts spent, categories of spending, etc.). Additionally, the data engine 150 can filter one or more of the data sets based on one or more of the retailer characteristics or one or more of the consumer characteristics. This enables retailers to receive additional data or extraneous data relevant to consumers or customers of the retailer (e.g., a customer of the retailer has a gift card), thereby allowing the retailer to inform or alert customers of relevant offers.

In one or more embodiments, the data engine 150 can gather or aggregate data from one or more other entities or individuals in similar situations and filter data accordingly. For example, when a concert or other event occurs, navigation to leave the concert venue may be provided differently to mitigate congestion on a roadway. That is, a first driver may be routed using a first path A-B-C, while a second driver may be routed using second path A-D-E-C based on the first driver being routed to the first path.

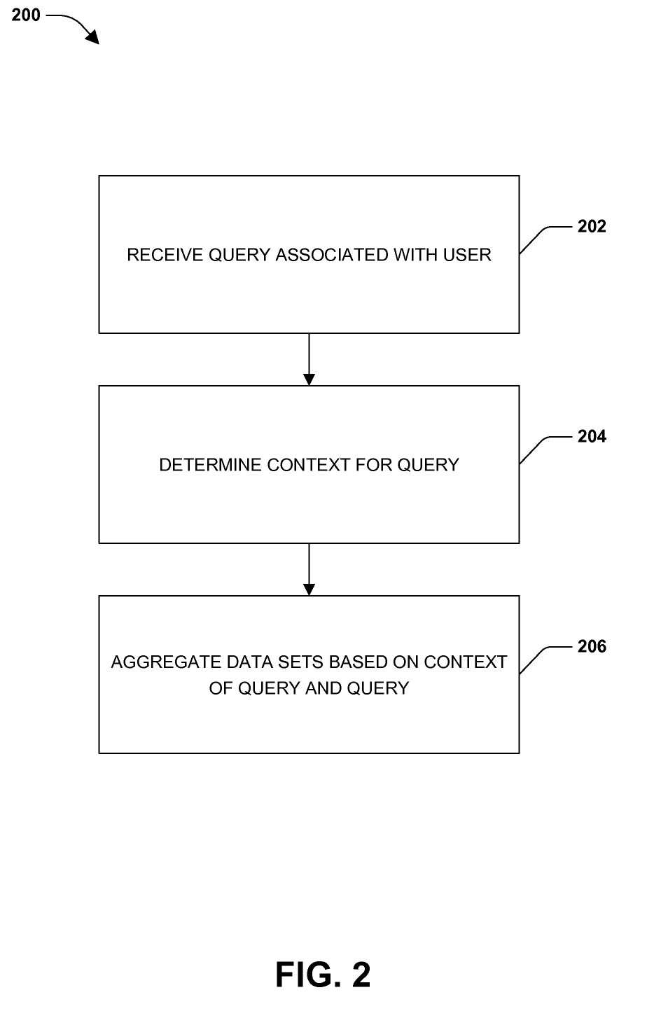

FIG. 2 is an illustration of an example flow diagram of a method 200 for search context association, according to one or more embodiments. At 202, an inquiry associated with a user can be received. The inquiry may be user generated or auto-generated. At 204, a context may be determined for the query. This means that a purpose (e.g., an intent), extraneous data, additional considerations, etc. may be taken into account while analyzing the query. For example, context can include financial incentives, fees, offers, offers sent, offers received, offers available, coupons, available gift card balances, spending habits, spending history, etc.

Context may also include user characteristics, such as behavioral history or intended actions. For example, if a user checks a balance associated with a wire and then checks a wire identification number, it may follow or be inferred that the user is conducting a search for a wire. That is, the context component 140 may determine the context of a query based on past interaction, search history, or other actions or behaviors (e.g., first checking a balance then checking a wire identification number). In other words, the context component 140 may make an inference that an individual is conducting a search for a wire because the individual checks a balance and then checks a wire ID. Accordingly, context may be determined as a goal of a user, which may be detected or defined by one or more user actions, one or more user behaviors, or one or more tasks that the user has on a to-do list. As yet another example of context, a context component, such as the context component 140 of FIG. 1, may detect one or more underutilized resources, unused resources, idle components, etc., and utilize those resources or components to provide a rendering for an auto-generated query. Other examples of user characteristics may include a location associated with a request, a location of a destination, a date of a query, a time of a query, etc.

In one or more embodiments, context can include one or more destination based characteristics, such as inventory of a store or a retailer, a length of a line, an estimated wait time, an estimated number of people, crime statistics associated with a location, whether a location is indoors or outdoors, etc. Additionally, context can include route based characteristics, such as traffic patterns, accident information, bus routes, public transit, hours of operation for the public transit or other types of transportation. Further context can include social media, such as social media messages, broadcasts, posts, likes, crowd sourcing data, news, RSS feeds, etc. Content can include one or more environmental factors, such as weather information, whether a location is indoor, outdoor, covered, heated, outside temperature, etc. At 206, one or more data sets may be aggregated, filtered, sorted, ranked, or organized based on the context of the query and/or the query. In other embodiments, the method 200 can include searching for one or more additional data sets based on the context of the query (e.g., search expansion).

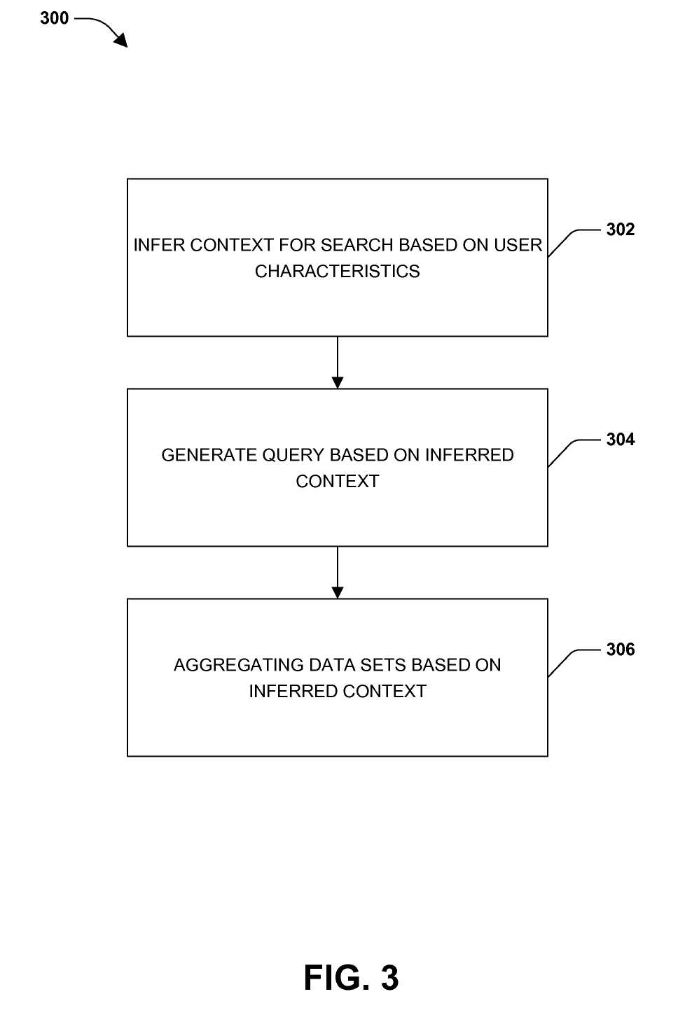

FIG. 3 is an illustration of an example flow diagram of a method 300 for search context association, according to one or more embodiments. At 302, a context for a search or a query can be inferred based on one or more user characteristics. At 304, a query can be generated based on the inferred context. At 306, one or more data sets can be aggregated, filtered, sorted, ranked, or organized based on the inferred context. In one or more embodiments, organization of the data sets can be based on the query.

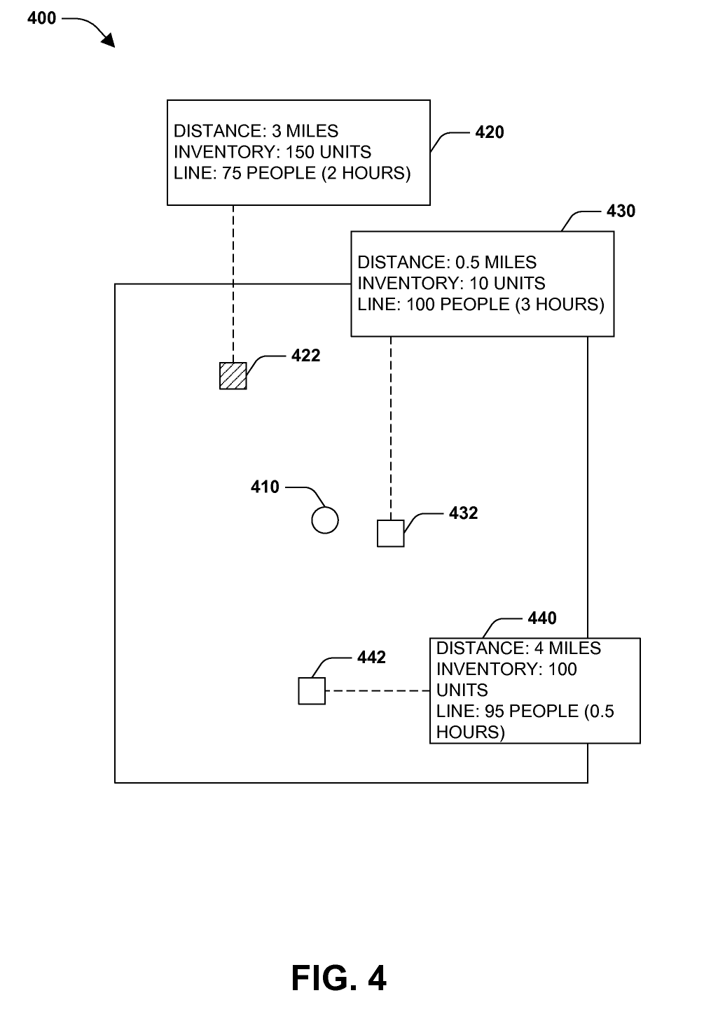

FIGS. 4-6 will be described with reference to the system 100 of FIG. 1 and one or more components thereof. FIG. 4 is an illustration of an example rendering 400 for search context association, according to one or more embodiments. As an example, a user 410 may be interested in purchasing a latest smartphone on a release day. The user 410 can submit a query to the search component 120. For example, the query may be “find me the latest brand X smartphone”. Here, the context component 140 may determine that the release date for the smartphone is the same day as the search query and that a goal associated with the query is to purchase the smartphone on the release day. The context component 140 may determine the context or release date based on a news feed, RSS feed, social media, trending searches from search engines, etc. Additionally, the context component 140 may determine that the brand X smartphone is a trending search on one or more search engines. That is, the context component 140 may detect the popularity of the smartphone by determining how popular one or more search terms of a query or search query are (e.g., the smartphone is the most searched phrase within the past 24 hours on a search engine).

As an example, when a new product (e.g., a new mobile phone) is released, limited quantities may be available. Users may be directed to different retailers or stores based on inventory levels, length of lines (which may be determined using social media among other things), distance, and the like. To this end, the context component 140 may augment the query with an inventory check at local retailers to provide the user with a retailer which has a higher probability of stocking the smartphone. As seen in FIG. 4, retailer A 422, retailer B 432, and retailer C 442 are located near the user 410. The context component 140 may pass or augment the query with an inventory parameter associated with the brand X smartphone and have the data engine 150 aggregate one or more associated data sets accordingly. For example, the data engine may aggregate a data set associated with a location of a retailer, an inventory level or stock level of the retailer (e.g., with respect to the brand X smartphone), and a number of people in line at the store (e.g., detected by the context component 140 by analyzing social media feeds or GPS locations on mobile devices, etc.). In one or more embodiments, the data engine may cross reference data from one source with data from another source.

For example, an inventory checker website may indicate that a retailer has one or more units of inventory available, but one or more social media posts may indicate that the retailer is out of stock for that unit of inventory. In other words, the data engine 150 may cross reference different sets of contextual data, such as social media with geospatial data, inventory data, or most any context data associated with a query. Here, the data engine 150 may determine that the social media posts are more reliable than the inventory checker site and filter corresponding locations from the query or search query. That is, an inventory checker website may indicate that retailer B 432 has 10 units in stock, while a social media post may indicate that retailer B 432 is sold out. Accordingly, retailer B 432 may be omitted from rendering 400 in one or more embodiments based on such a social media post. The presentation component 160 can render the rendering 400 and provide the user with information 420, 430, and 440 for retailers A 422, B 432, and C 442, respectively.

Additionally, the data engine 150 may provide one or more suggestions for the user. For example, the data engine 150 may highlight retailer A 422 because that the user 410 has the best chance of getting a brand X smartphone there or a retailer with a shortest line. Here, the data engine 150 may determine that the user 410 has the best chance of achieving this goal and suggest retailer A 422 because there is a greater amount of difference between the inventory level and the line of people than at other retailers, as indicated by tag 420. Accordingly, the data engine 150 may place a higher value or score on a retailer that is farther from the user 410 when it is determined that the user has a better chance of obtaining a goal associated with the query (e.g., purchasing the brand X smartphone). In this way, the data engine 150 can determine a context for a query based on one or more destination based characteristics, such as an inventory level of one or more of the retailers 422, 432, or 442. Similarly, the data engine 150 can determine a context for the query based on one or more social media factors (e.g., which may be related to one or more of the destination based characteristics), such as a length of a line, or estimated wait time, for example.

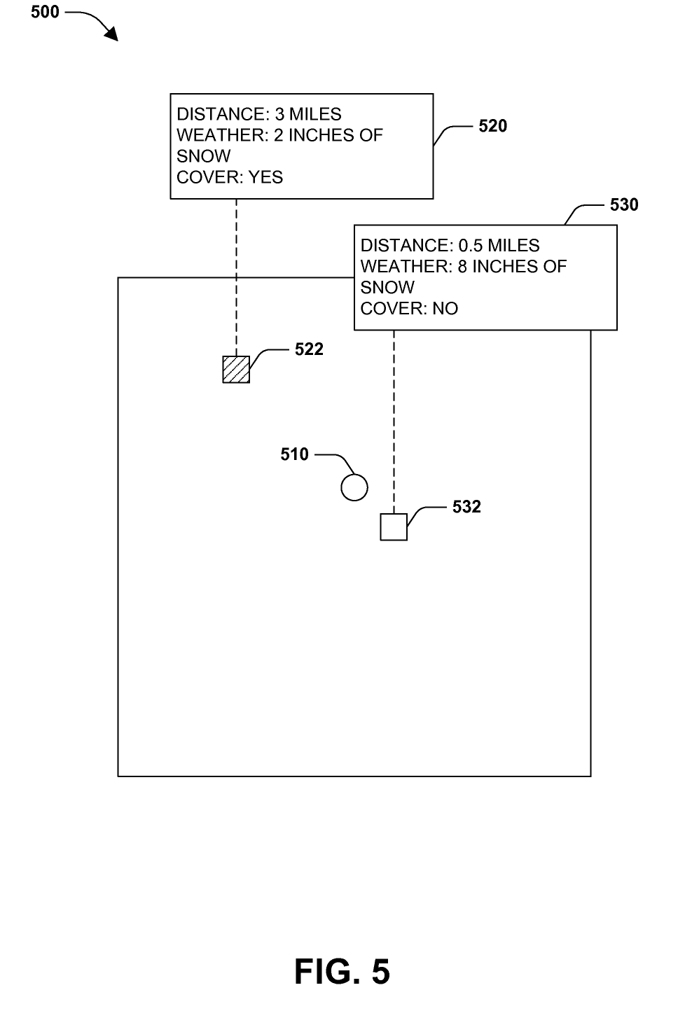

FIG. 5 is an illustration of an example rendering 500 for search context association, according to one or more embodiments. As an example, a user 510 may be searching for an ATM. Here, the user 510 may submit a query to the search component, such as the search component 120 of FIG. 1. The query may be in natural language format, and include a phrase such as, “Find me an ATM”, “ATM 90028”, or “Find an ATM near my location”, for example.

The context component 140 may infer that because the user 510 is searching for an ATM, the user is planning on travelling to the ATM shortly thereafter executing the search or the query. The context component 140 may determine that a goal of the user 510 is to withdraw money or get cash from a bank account of the user. As a result of this inference, the context component 140 may append a location such as a zip code to the query or search query. In this example, the context component 140 may analyze one or more environmental factors, such as weather, outside temperature, etc. That is, when the temperature is above or below a temperature threshold, the context component 140 may determine or infer that a user would prefer to be indoors, outdoors, use a drive through ATM, etc. That is, the context component 140 may include weather as a factor to consider or a data set that the data engine 150 should retrieve. Here, a first ATM 522 and a second ATM 532 are located within a proximity of the user 510. Accordingly, the data engine 150 can retrieve one or more data sets associated with weather conditions in addition to locations or distances associated with one or more of the ATMs 522 and 532. As indicated at 530, the second ATM is half a mile from the user 510 and has experienced approximately 8 inches of snow within the past day, while the first ATM 522 is three miles away from the user 510 and has reportedly received less snow than the first ATM.

Additionally, the first ATM 522 has cover from the elements and the second ATM 532 is not covered from the elements, and the context component 140 may direct the data engine 150 to retrieve data sets related to one or more destination based characteristics, such as whether one is required to leave a vehicle to conduct a transaction, whether or not a drive-thru is available, whether a location is indoors or outdoors (e.g., whether an ATM is located inside, such as inside a grocery store, or outside of the store), a crime rate for an area, whether a location has cover from the elements, etc. For example, the data engine 150 may recommend (e.g., as indicated by the pattern within 522) the first ATM 522 over the second ATM based on the cover that the first ATM provides or the milder weather associated with the first ATM 522, even though the second ATM 532 may be closer in proximity to the user 510.

In other embodiments, the context component 140 may pass an inferred goal of the user or a context of a query to the data engine 150 and have the data engine 150 augment the query with one or more terms which can facilitate achievement of the inferred goal. For example, if a user 510 submits a query for an ATM with the goal or purpose of withdrawing cash, the context component 140 may determine that the context of the search or the goal of the search is to get cash (where an ATM may be a source of cash from the user's bank account). In this example, the data engine 150 may receive the query and augment the query with a search for supermarkets or retailers which allow an individual to execute a debit card cashback transaction or a cash out transaction. That is, the data engine 150 may include retailers which allow customers to withdraw additional cash as part of a purchase or a transaction made through that retailer.

Additionally, the context component 140 may determine a context based on financial incentives, such as whether or not an ATM has a fee associated therewith or whether there is a minimum purchase amount associated with a debit card cashback transaction. When multiple ATMs are available (without fees) nearby, the data engine may prioritize the fee-free ATMs over ATMs which may charge the user a fee. However, if the context component 140 determines that a user is in a hurry (e.g., has an upcoming appointment detected by the context component 140, such as on a task-list or calendar appointment) or that the distance is greater than a distance threshold (e.g., the drive is greater than a ten minute drive time or ten mile drive distance between the fee-based ATM and the no-fee ATM), then the data engine 150 may direct a user to a fee-based ATM over a non-fee ATM or rank the fee-based ATM which is closer to the user higher than the non-fee ATM.

When the user 510 submits a query for an ATM, the context component 140 may infer or determine a goal for the query or the user or the context of the query (e.g., obtain cash). To this end, the data engine 150 may include one or more data sets of retailer locations in addition to one or more data sets of ATM locations and/or bank branch locations. The data engine 150 may select, rank, score, refine, or narrow one or more of the retailer locations based on whether a retailer offers debit card cashback transactions (e.g., cash out transactions) or not. The data engine 150 may conduct the selection, ranking, scoring, etc. based on one or more destination based characteristics, such as crime rates around a location of an ATM or a retailer, whether or not the retailer offers a type of transaction, a location of a potential match, etc. As an example, the data engine 140 may direct a user 510 towards ATMs or destinations with lower crime rates than other ATMs with higher crime rates which may be closer in proximity to a user. The presentation component 160 may present one or more options to the user 510. In this way, a context of a search or a query can be augmented with useful search terms to expand or narrow a query in a way which facilitates achieving a goal of a query.

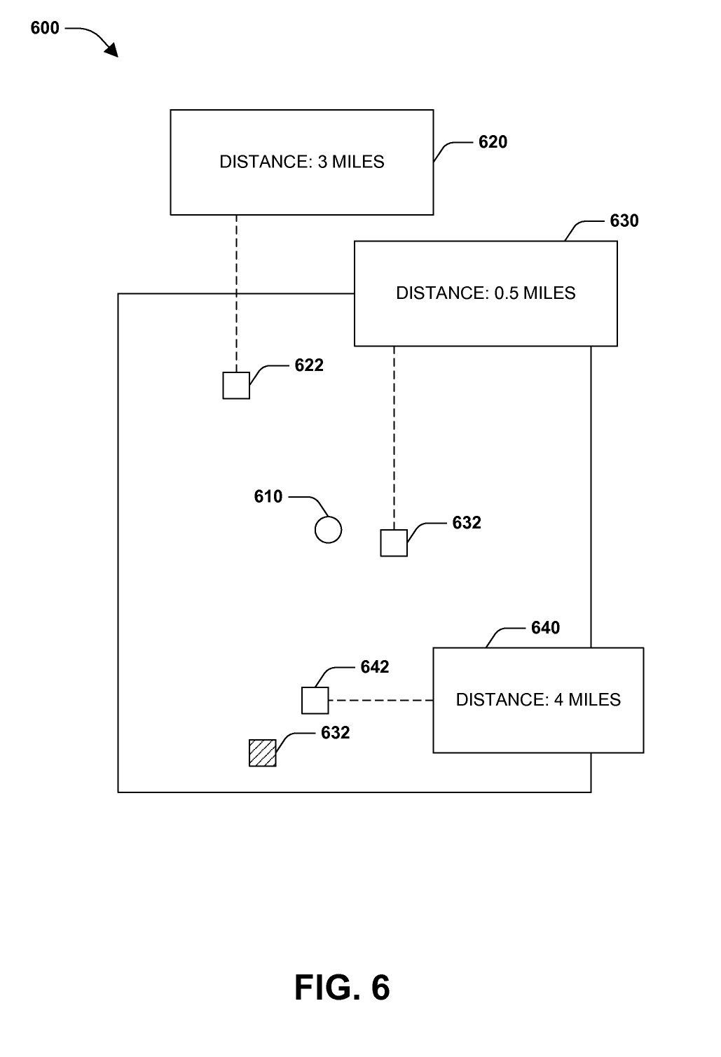

FIG. 6 is an illustration of an example rendering 600 for search context association, according to one or more embodiments. In FIG. 6, a context component 140 may infer or determine a context of a query based on one or more user characteristics. Here, a user characteristic may include one or more tasks associated with a user 610, such as a task on a to-do list of the user 610. For example, a search component 120 may receive a query which when executed by the data engine 150, returns one or more results, locations, destinations, potential matches, etc. The context component 140 may utilize one or more tasks on a user's task list as a context for the query. This means that the context component 140 may have the data engine 150 consider additional factors, in determining a result, scoring, or ranking one or more potential matches.

For example, if the context component 140 detects that the user has a task at location 632, and the data engine returns a first location 622, a second location 632, and a third location 642, the data engine may suggest (e.g., as indicated by the hatching of 632) that the user 610 select location 642 to facilitate completion of a task associated with location 632, which is in proximity of location 642, despite locations 622 and 632 being closer in proximity to the user 610, as indicated by distances 620, 630, and 640, respectively. To this end, the presentation component 160 may present a rendering which suggests location 642 because of the proximity of 642 to 632, which is a location associated with a task for the user. Additionally, the presentation component 160 may suggest that the user complete the task at location 632 in addition to, on the way to, or on the way from 642.

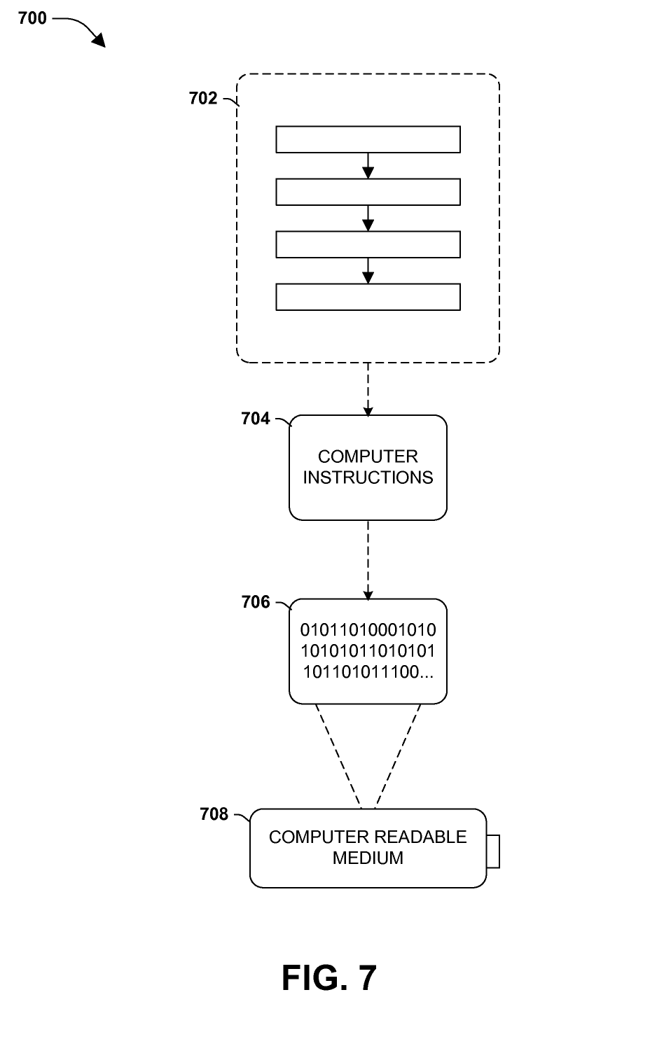

Still another embodiment involves a computer-readable medium including processor-executable instructions configured to implement one or more embodiments of the techniques presented herein. An embodiment of a computer-readable medium or a computer-readable device that is devised in these ways is illustrated in FIG. 7, wherein an implementation 700 includes a computer-readable medium 708, such as a CD-R, DVD-R, flash drive, a platter of a hard disk drive, etc., on which is encoded computer-readable data 706. This computer-readable data 706, such as binary data including a plurality of zero's and one's as shown in 706, in turn includes a set of computer instructions 704 configured to operate according to one or more of the principles set forth herein. In one such embodiment 700, the processor-executable computer instructions 704 are configured to perform a method 702, such as the method 200 of FIG. 2 or the method 300 of FIG. 3. In another embodiment, the processor-executable instructions 704 are configured to implement a system, such as the system 100 of FIG. 1. Many such computer-readable media are devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 8 and the following discussion provide a description of a suitable computing environment to implement embodiments of one or more of the provisions set forth herein. The operating environment of FIG. 8 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions can be distributed via computer readable media as will be discussed below. Computer readable instructions can be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 8 illustrates a system 800 including a computing device 812 configured to implement one or more embodiments provided herein. In one configuration, computing device 812 includes at least one processing unit 816 and memory 818. Depending on the exact configuration and type of computing device, memory 818 may be volatile, such as RAM, non-volatile, such as ROM, flash memory, etc., or a combination of the two. This configuration is illustrated in FIG. 8 by dashed line 814.

In other embodiments, device 812 includes additional features or functionality. For example, device 812 can include additional storage such as removable storage or non-removable storage, including, but not limited to, magnetic storage, optical storage, etc. Such additional storage is illustrated in FIG. 8 by storage 820. In one or more embodiments, computer readable instructions to implement one or more embodiments provided herein are in storage 820. Storage 820 can store other computer readable instructions to implement an operating system, an application program, etc. Computer readable instructions can be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media is part of device 812.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 812 includes input device(s) 824 such as keyboard, mouse, pen, voice input device, touch input device, infrared cameras, video input devices, or any other input device. Output device(s) 822 such as one or more displays, speakers, printers, or any other output device may be included with device 812. Input device(s) 824 and output device(s) 822 can be connected to device 812 via a wired connection, wireless connection, or any combination thereof. In one or more embodiments, an input device or an output device from another computing device can be used as input device(s) 824 or output device(s) 822 for computing device 812. Device 812 can include communication connection(s) 826 to facilitate communications with one or more other devices.

A classifier is a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to prognose or infer an action that a user desires to be automatically performed. In the case of the system 100 of FIG. 1, for example, attributes can be device properties or other device-specific attributes provided by the detection component 140 or determined from the data set or data set properties, and the classes can be categories or areas of interest (e.g., levels of priorities).

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, one or more embodiments can employ classifiers that are explicitly trained (e.g., via a generic training data) as well as implicitly trained (e.g., via observing user behavior, receiving extrinsic information). For example, SVMs can be configured via a learning or training phase within a classifier constructor and feature selection module. Thus, the classifier(s) can be used to automatically learn and perform a number of functions, including but not limited to determining according to a predetermined criteria.

According to one or more aspects, a method for search context association is provided, including receiving a query associated with a user, determining a context for the query, wherein the context of the query is associated with one or more user characteristics, one or more environmental factors, one or more social media factors, one or more route based characteristics, or one or more destination based characteristics, and aggregating or filtering one or more data sets in response to the query based on the context of the query.

The method can include rendering a response to the query based on the context of the query. One or more of the user characteristics can include a location of the user and the query is associated with one or more potential destinations associated with one or more corresponding destination locations. One or more of the environmental factors can be indicative of a weather pattern at the location of the user, one or more of the destination locations, or along one or more routes from the location of the user to one or more of the potential destinations. One or more of the route based characteristics can be indicative of a traffic pattern, estimated travel time, or distance associated with one or more routes between the location of the user and one or more of the potential destinations.

In one or more embodiments, the query for the user can be automatically generated. In other embodiments, the query for the user can be generated by the user. The method can include filtering one or more data sets based on the context of the query. The method can include searching for one or more additional data sets based on the context of the query. Additionally, one or more of the data sets can be indicative of one or more potential destinations associated with the query.

According to one or more aspects, a system for search context association is provided, including a search component for receiving a query associated with one or more consumers, a context component for determining a context for the query, wherein the context of the query is associated with one or more consumer characteristics of one or more of the consumers, and a data engine for aggregating or filtering one or more data sets in response to the query based on the context of the query.

The data engine can aggregate one or more of the data sets based on one or more retailer characteristics. One or more of the retailer characteristics can include one or more offers from one or more retailers. The data engine can filter one or more of the data sets based on one or more of the retailer characteristics or one or more consumer characteristics. One or more of the consumer characteristics can include one or more offers received by one or more of the consumers. The context component can determine the context for the query based on a physical location of one or more of the consumers.

According to one or more aspects, a method for search context association is provided, including inferring a context for a search based on one or more user characteristics of a user, generating a query for the search based on the inferred context, and aggregating or filtering one or more data sets in response to the query based on the inferred context. The method can include rendering one or more of the data sets based on the inferred context or filtering one or more of the data sets based on the inferred context. One or more of the user characteristics can include a search history for the user.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” can include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A method for search context association, comprising:
receiving a query associated with a user;
determining a context for the query, wherein the context of the query is associated with one or more user characteristics, one or more environmental factors, one or more social media factors, one or more route based characteristics, or one or more destination based characteristics; and
aggregating or filtering one or more data sets in response to the query based on the context of the query, wherein the receiving, the determining, or the aggregating is implemented via a processing unit.

2. The method of claim 1, comprising rendering a response to the query based on the context of the query.

3. The method of claim 1, wherein one or more of the user characteristics comprises a location of the user and the query is associated with one or more potential destinations associated with one or more corresponding destination locations.

4. The method of claim 3, wherein one or more of the environmental factors is indicative of a weather pattern at the location of the user, one or more of the destination locations, or along one or more routes from the location of the user to one or more of the potential destinations.

5. The method of claim 3, wherein one or more of the route based characteristics is indicative of a traffic pattern, estimated travel time, or distance associated with one or more routes between the location of the user and one or more of the potential destinations.

6. The method of claim 1, wherein the query for the user is automatically generated.

7. The method of claim 1, wherein the query for the user is generated by the user.

8. The method of claim 1, comprising filtering one or more data sets based on the context of the query.

9. The method of claim 1, comprising searching for one or more additional data sets based on the context of the query.

10. The method of claim 1, wherein one or more of the data sets is indicative of one or more potential destinations associated with the query.

11. A system for search context association, comprising:
a search component for receiving a query associated with one or more consumers;
a context component for determining a context for the query, wherein the context of the query is associated with one or more consumer characteristics of one or more of the consumers; and
a data engine for aggregating or filtering one or more data sets in response to the query based on the context of the query, wherein the search component, the context component, or the data engine is implemented via a processing unit.

12. The system of claim 11, wherein the data engine aggregates one or more of the data sets based on one or more retailer characteristics.

13. The system of claim 12, wherein one or more of the retailer characteristics comprises one or more offers from one or more retailers.

14. The system of claim 12, wherein the data engine filters one or more of the data sets based on one or more of the retailer characteristics or one or more of the consumer characteristics.

15. The system of claim 11, wherein one or more of the consumer characteristics comprises one or more offers received by one or more of the consumers.

16. The system of claim 11, wherein the context component determines the context for the query based on a physical location of one or more of the consumers.

17. A method for search context association, comprising:
inferring a context for a search based on one or more user characteristics of a user;
generating a query for the search based on the inferred context; and
aggregating or filtering one or more data sets in response to the query based on the inferred context, wherein the inferring, the generating, or the aggregating is implemented via a processing unit.

18. The method of claim 17, comprising rendering one or more of the data sets based on the inferred context.

19. The method of claim 17, comprising filtering one or more of the data sets based on the inferred context.

20. The method of claim 17, wherein one or more of the user characteristics comprises a search history for the user.
